(19) United States
(12) Patent Application Publication
(10) Pub. No.: US 2015/0176810 A1
(43) Pub. Date: Jun. 25, 2015

(54) LIGHTING DEVICE AND METHOD FOR PROVIDING LIGHT

(71) Applicant: SHARP KABUSHIKI KAISHA, Osaka-shi, Osaka (JP)

(72) Inventors: Sarah Anne Mitchell, Oxford (GB); David James Montgomery, Oxford (GB); Peter John Roberts, Oxford (GB); Jonathan Heffernan, Sheffield (GB); James Rowland Suckling, Surrey (GB); Samir Rihani, Ipswich (GB)

(21) Appl. No.: 14/414,829

(22) PCT Filed: Jul. 22, 2013
(86) PCT No.: PCT/JP2013/004451

§ 371 Date: Jan. 14, 2015

Related U.S. Application Data
(63) Continuation of application No. 13/563,117, filed on Jul. 31, 2012, now abandoned.
(60) Provisional application No. 61/673,902, filed on Jul. 20, 2012.

(51) Int. Cl. F21V 13/14; F21K 99/00

(52) U.S. Cl. CPC F21V 13/14; F21K 9/1375; F21Y 2101/02

(57) ABSTRACT

A lighting device includes a transparent optical cavity having an exit surface including a specularly reflective material arranged to reflect light into the cavity, the exit surface having a plurality of apertures formed therein, a base surface including a specularly reflective material arranged to reflect light into the cavity, and at least one light receiving surface arranged relative to the base surface and configured to receive light from a light source. The plurality of apertures are arranged to maximize at least one of uniformity, angular distribution, efficiency or luminous intensity of light exiting the exit surface, and a distribution of light received at the light receiving surface is altered by at least one of a combination of the exit surface and the base surface, or the light receiving surface.

### TECHNICAL FIELD

This invention relates to a directional luminaire (for example a spot or accent light) capable of providing light in an indoor or outdoor environment. It further refers to spotlights that can have a thin profile and to those that require reduced glare. This luminaire has the further capability of providing angle and direction-controlled illumination.

### BACKGROUND ART

This application claims priority of U.S. Provisional Application No. 61/673,902 filed on Jul. 20, 2012 and U.S. application Ser. No. 13/563,117 filed on Jul. 31, 2012, which are incorporated herein by reference in its entirety.

Directional luminaires such as spotlights, accent lights, downlighters, etc. are used in a wide variety of applications in residential, commercial and industrial premises. They are used particularly where a high surface brightness is required such as task lighting in kitchens and in retail accent lighting. These luminaires, at the basic level, consist of two components: a light engine, which generates light and an optic that collimates light emitted by the light engine. Most light engines, and all common ones like tungsten Halogen, HID, LED, CFL, OLED etc. emit with a very broad angular distribution (isotropic or Lambertian). The optic then collimates this light into the required directionality. This in turn increases the luminous intensity of the luminaire allowing higher brightness in smaller areas.

The most common and simplest form of optic is a reflector cup and can take many forms, such as a TIR optic or metal reflector, and these are commonly known.

To make an effective spotlight the etendue of the system must be conserved, hence the light engine emitting area must be much smaller than the reflector output front area. Hence a small point-like light source is ideal. This is often not the case with CFL or OLED, but is possible with LED. The optic also needs to capture and redirect as much light as possible from the source, which means that the reflector also must have a significant thickness relative to the aperture area, a greater thickness if the collimation is greater.

Modern designs of lighting systems often now require thin or flat lighting structures and necessarily it has been very difficult to make a directional light source that is very thin. Bright low thickness spotlights have typically used many small light sources with small reflectors. For bright applications there are limitations on LED size, hence front aperture and thickness and for typical spotlights, a minimum optic thickness has tended to be around 12-14 mm before significant losses in efficiency occur.

In addition, small or point-like light sources, although often convenient in terms of size, weight, and ability to integrate into a luminaire, often have a disadvantage from a users' point of view in that the light is emitted from a small area; even if not dangerously bright, if viewed directly or in peripheral vision a small source can be uncomfortable to look at, and this is known as glare. Large area luminaires are desirable in some circumstances because they allow a small source of a given brightness to emit over a larger surface area, thus reducing the perceived surface brightness, and increasing the visual comfort of the light source. Lightguide luminaires are commonly known in both lighting and display backlight applications as a way to create a large area light source from one or more small or point-like light sources. In their most common form, light is in-coupled from a source to a material such as a transparent plastic (PMMA, acrylic, or similar) or glass, and is then transported through the material by total internal reflection (TIR), and only out-coupled when it encounters an out-coupling feature designed to frustrate TIR. These lightguides are inexpensive and easy to manufacture, but particularly for larger examples, the material used makes them heavy. In addition, the angular distribution of light emitted from the lightguide is normally non-optimal for the intended purpose and requires multiple extra optical films to turn the light into the desired emission directions.

An alternative approach is to fabricate a reflecting cavity. This approach is adopted in U.S. Pat. No. 7,726,828 (Sato, Jun. 1, 2010). With reference to FIG. 1, the emitting object is a cavity or lightguide with a light source at the centre on the bottom plane. Possible light steering devices include a ‘radiation side reflecting means’ above the light source such that the light changes direction and is directed preferentially away from the light source towards the sides of the cavity. The cavity or lightguide is surrounded by reflecting media which may be specular or diffuse. At least one surface allows for out-coupling via holes in the reflecting material or otherwise interrupting the reflection.

In EP2163807 (Sato, Mar. 17, 2010), as U.S. Pat. No. 7,726,828, the large area light source is formed of a reflecting cavity, as seen in FIG. 2. In this case, a specific relationship between opening ratio, A, (fraction of area over which light is extracted from the cavity) and radius from the light source, x, is specified by the relation A=bx²+c (b and c are constants). The layout of the hole pattern may also change as a function of radius such that, for example, the hole layout near the light source is different to that found at larger radii.

In U.S. Pat. No. 7,494,246 (Harbors, Feb. 24, 2009) multiple LEDs are distributed in a reflective cavity as shown in FIG. 3. The cavity has reflective sides, one of which has small holes punched through to extract the light. In order to further control the emission properties of the illumination, the angle of light extracted from the cavity is modified by small lenses located at each hole, or by shaping the holes into truncated cones.

In EP 2312199 (Sato, Aug. 6, 2008) a directional light source is used to obtain a large flat surface source using a pattern of holes that allow more transmission further from the light source.

### SUMMARY OF INVENTION

In general out-coupling light from lightguides and reflection from diffuse reflectors is not a good way of providing precise control over the angular properties of emitted light from a lightguide or luminaire; approximate beam shaping in extraction from lightguides is possible by the careful design of extraction features, but in general for more precise beam-shaping additional optical films (such as brightness enhancement films) are needed. Diffuse reflectors cause diffuse reflection of light, and thus emission from a luminaire employing diffuse reflection as the primary means of light propagation will be approximately Lambertian in distribution. This is necessarily a requirement of the rule of etendue, whereby for all “normal” geometrical optics, the product of area and mean solid angle of emission is a constant.

One solution is to use lenses or mirrored reflectors, however, these components must be bigger than the source for strong collimation and by their nature, must be physically separated from the source along the beam path, hence a thick optical component.

A device and method in accordance with the present invention involves a different type of optic that provides four key features, where all do not exist together in the prior art. These are:
Narrow beam (narrow angular distribution-high brightness)
Slim profile (design freedom)
Large area of emission (reduced glare)
Single light source (cheaper and simpler driver electronics) or multiple light sources

The optic includes a cavity with one or more light sources (e.g. LED) placed in it. The cavity is lined with high reflectivity material (e.g. interference film or a metallised layer). Around each light source the surface slopes upwards at a small angle around the source. The top surface of the cavity consists of a series of patterned holes or apertures that are designed to maximize luminous intensity, efficiency or other characteristic.

Light form the light sources reflects a number of times from the sides and exits the cavity through the holes. The angle to the lower surface changes the angle of the light such that the light becomes more collimated before exiting the cavity. This results, with an appropriate pattern of apertures, in a luminaire with a controlled angular distribution.

The low angle of the surface and the fact that the light reflects a number of times means that the thickness of the optic can be substantially thinner than a simple reflector using the same number of light sources.

The light also exits the cavity through the array of holes hence achieving a wide area narrow beam source.

The light source is then not seen directly and the light is spread enabling a lower retinal brightness from the luminaire and hence a reduced glare capacity.

An alternative embodiment is in the use of a light source that is already directed and without a slope to the lower surface of the cavity. In this case a directed light source is a light source that is already of a collimated character, either intrinsically (e.g. a laser) or an LED that has a optic already present (e.g. a smaller reflector cup) separate from the invention optic. This also refers to the case where the light receiving surface of the inventive optic applies a collimated character to the light (e.g. a curved lens-like surface).

In using a specular reflector, the light emitted from the source will travel in straight lines radially outwards. This introduces an extra, important, constraint in determining the position of holes in the surface of the luminaire; not only is the hole density defined as a function of radius, but also holes are carefully placed as a function of radius and angle to ensure that emission from holes at larger radii is not obstructed or shadowed by holes at smaller radii.

Thus, a device and method in accordance with the present invention can use a specular reflector in combination with a light source of specified angular emission characteristics. The reflector is formed into a cavity surrounding the light source, and holes are formed through which the light is extracted from the cavity. Through the use of a specular reflector, the angular properties of the source are preserved on extraction from the cavity. Holes are placed in order that the light is extracted uniformly over the surface of the reflecting cavity, and further, hole position is determined such that holes at larger radii are able to extract sufficient light and are not shadowed by extraction from holes at smaller radii.

Further aspects of the invention concern additional optical features which may be used to steer light inside the cavity, either by modifying the cavity walls such that the angle of light rays inside the cavity is altered on reflection with the cavity walls, or by introducing new optical features within the cavity.

The use of multiple directed light sources (or light sources with different surrounding slopes) can then be used to create a luminaire with modifiable angular emission characteristics either in angular spread or in direction from the luminaire, or both together.

The embodiments of this invention are summarized as applying to luminaires for general lighting but similarly the same technology can be used for uniform backlighting for display panels such as liquid crystal displays. The methods described here can produce collimated or controllable backlighting for phone, monitor, TV or signage applications. In the case of the luminaire application, the brightness and distribution is important. In the case of a display illumination application uniformity is also important.

According to one aspect of the invention, a lighting device includes: a transparent optical cavity including an exit surface including a specularly reflective material arranged to reflect light into the cavity, the exit surface having a plurality of apertures formed therein, a base surface including a specularly reflective material arranged to reflect light into the cavity, and at least one light receiving surface arranged relative to the base surface and configured to receive light from a light source, wherein the plurality of apertures are arranged to maximize at least one of uniformity, angular distribution, efficiency or luminous intensity of light exiting the exit surface, and wherein a distribution of light received at the light receiving surface is altered by at least one of a combination of the exit surface and the base surface, or the light receiving surface.

According to one aspect of the invention, a method of providing glare-free light in a predefined area having at least one pre-existing light source arranged therein includes arranging the light receiving surface of the lighting device described herein relative to the pre-existing light source so as to receive light emitted by the preexisting light source at the light receiving surface.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF DRAWINGS

In the annexed drawings, like references indicate like parts or features:

FIG. 1 illustrates a light emitting device according to U.S. Pat. No. 7,726,828.

FIG. 2 illustrates a light emitting device according to EP2163807.

FIG. 3 illustrates a light emitting device according to U.S. Pat. No. 7,494,246.

FIG. 4 illustrates an exemplary luminaire in accordance with a first embodiment of the invention.

FIG. 5 illustrates the luminous intensity and angular distribution possible with a luminaire in accordance with a first embodiment of the invention.

FIG. 6 shows an exemplary multi-source optic structure in accordance with the first embodiment.

FIG. 7a shows possible structural realizations of the first embodiment.

FIG. 7b shows possible structural realizations of the first embodiment.

FIG. 8 shows an exemplary luminaire in accordance with a second embodiment of the invention.

FIG. 9 illustrates an exemplary ray path in the second embodiment.

FIG. 10 illustrates an exemplary relationship between out-coupling hole size and ray path.

FIG. 11 illustrates an exemplary distribution of out-coupling holes on reflective surface.

FIG. 12 illustrates alternative angular distributions of the light source and output from the luminaire in accordance with a third embodiment of the invention.

FIG. 13 illustrates an exemplary lens system to control angular output from the source.

FIG. 14 illustrates an exemplary reflector system to control angular output from the source.

FIG. 15a illustrates an exemplary a light source with emission distribution which is not symmetric about the luminaire normal axis in accordance with a fourth embodiment of the invention.

FIG. 15b illustrates an exemplary a light source having multiple LEDs with differing angular distributions in accordance with an embodiment of the invention.

FIG. 16 illustrates use of the luminaire as a backlight.

FIG. 17 illustrates exemplary out-coupling hole distribution for a backlight embodiment.

FIG. 18 illustrates optional extra optical films used in a backlight embodiment.

FIG. 19 illustrates maximum out-coupling hole spacing for a given distribution in accordance with a sixth embodiment of the invention.

FIG. 20a illustrates an exemplary luminaire where a reflective cavity is retrofit over an external light source in accordance with a seventh embodiment of the invention.

FIG. 20b illustrates an exemplary luminaire where a reflective cavity is retrofit over an external light source in accordance with a seventh embodiment of the invention.

FIG. 20c illustrates an exemplary luminaire where a reflective cavity is retrofit over an external light source in accordance with a seventh embodiment of the invention.

FIG. 21 illustrates using multiple light sources within a reflective cavity in accordance with an eighth embodiment of the invention.

FIG. 22 illustrates the use of additional optical features for light steering within the plane of the reflective cavity in accordance with a ninth embodiment of the invention.

FIG. 23a illustrates exemplary optical features used for light steering.

FIG. 23b illustrates exemplary optical features used for light steering.

FIG. 24a illustrates use of optical features for light steering in directions out of the plane of the reflective cavity in accordance with a tenth embodiment of the invention.

FIG. 24b illustrates use of optical features for light steering in directions out of the plane of the reflective cavity in accordance with a tenth embodiment of the invention.

FIG. 25 illustrates use of an exemplary continuous geometry instead of individual optical features in accordance with an eleventh embodiment of the invention.

FIG. 26 illustrates use of an exemplary continuous geometry instead of individual optical features, showing cross section through reflective cavity.

FIG. 27 illustrates use of a continuous geometry instead of individual optical features.

FIG. 28a illustrates an embodiment using a diffuser or scattering medium beneath the exit surface.

FIG. 28b illustrates an embodiment using a diffuser or scattering medium on top of the exit surface.

FIG. 28c illustrates an embodiment using a perforated diffuser or scattering medium on to of exit surface.

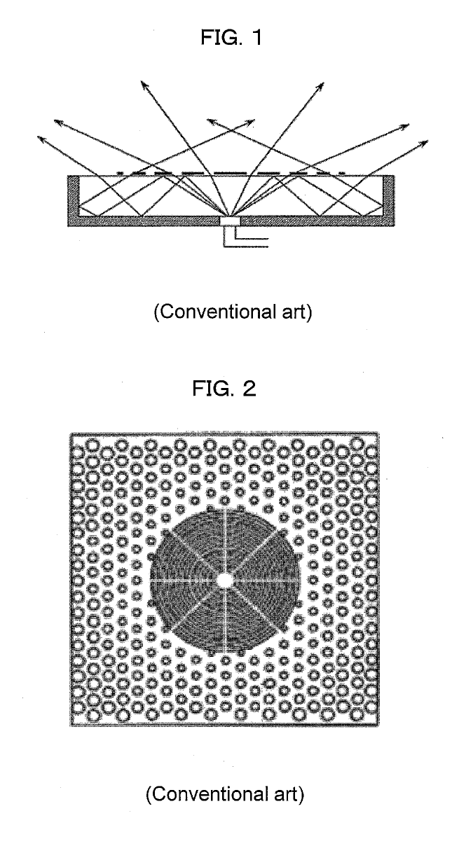

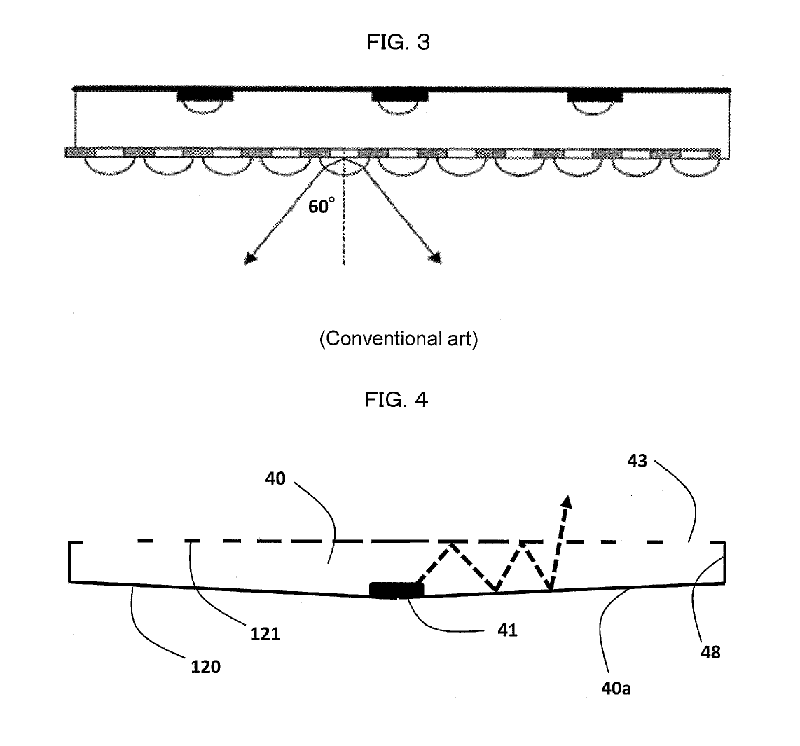

### DESCRIPTION OF EMBODIMENTS

A lighting device in accordance with the present invention includes a transparent optical cavity having an exit surface, a base surface and a light receiving surface formed in or relative to the base surface. The exit surface and the base surface include a specularly reflective material, and a plurality of apertures are formed in the exit surface, wherein the apertures are arranged to maximize at least one of uniformity, angular distribution, efficiency or luminous intensity of light exiting the exit surface. Further, at least one of a combination of the exit surface and base surface, or the light receiving surface alters a distribution of light received at the light receiving surface.

FIG. 4 shows a preferred embodiment in accordance with the present invention. A light source, 41, is used and this is referred to in subsequent discussions as an LED, but the invention is not limited to this type of light source.

The optic consists of a cavity, 40, which can be air filled or can be a transparent optical material such as PMMA (Poly(methyl methacrylate)). The cavity includes a base surface 40a shaped with a slope, 120, extending away from the light source (e.g., sloping toward the exit surface). If the light source is point-like, then the slope is circularly symmetric about the source. If the source is linear, then the slope is also linear away from the source.

The slope, 120, may be straight or may be curved. The curve may be a conic section, in particular a section or arc from a circle, ellipse or parabola in cross section.

The cavity has end pieces, 48 (also referred to as light receiving surface 48), that can be straight or lens shaped and are specularly or diffusely reflecting (e.g., the end pieces may have a lens shape thereby providing a curved reflector). The top surface, 121, consists of a specularly reflecting area with apertures 43 cut into the surface. The apertures consist of a pattern of holes whose size and distribution vary with distance and angle away from the light source. The top surface of the top reflector (away from the light source) need not be reflecting and may be any colour as it will not affect the performance of the device.

The specular reflecting surface may include interference film (such as the commonly available ESR film) or a metallised reflecting layer such as silver or aluminium.

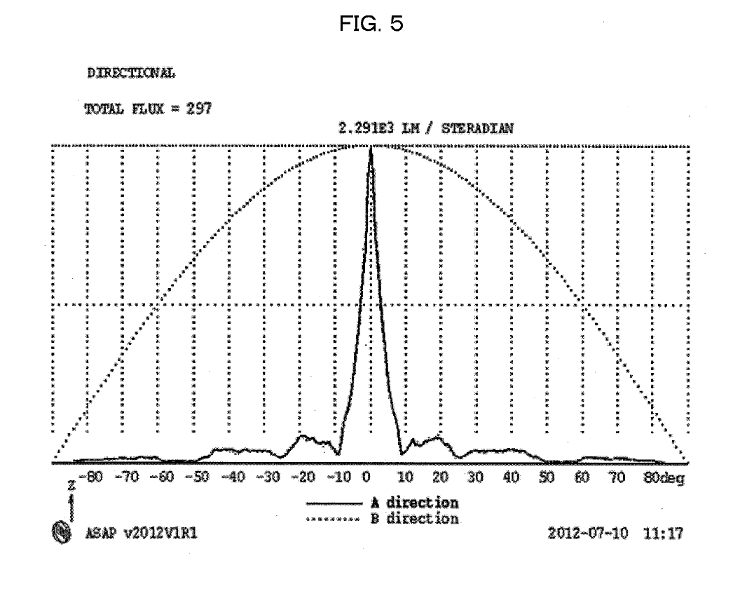

The optic works by reflecting and recycling light between the top reflector 121 and the slope reflector 120 such that the light is collimated. The light is out-coupled from the cavity by the holes 43 in the top reflector and proper positioning of these holes can be done to optimize both overall efficiency, surface emitted light uniformity (both apparent and actual), angular distribution and the peak luminous intensity as a function of slope angle, thickness and light source size. A simulated example of the emitted angular distribution is shown in FIG. 5.

Overall efficiency is defined as the ratio of emitted energy over all angles to the optical or electrical energy being input.

Luminous intensity is the brightness per unit solid angle of the light in candelas or watts per steradian from the luminaire.

Angular distribution is the variation of luminous intensity with angle away from the surface normal. For cylindrically symmetric luminaires this will be a function only of the polar angle.

Surface uniformity is defined as the ratio of maximum to minimum luminance per unit area of the emitting surface of the luminaire. It can be actual, where all light is taken into account, or apparent, which is from the point of view of a distant observer of the surface. A large area of emission with high apparent uniformity will result in low retinal illumination and hence low glare, even if the luminous intensity is high. Current spotlights using reflectors typically have very non-uniform distributions.

There may be a small area around the LED where the bottom surface is parallel to the top surface (not illustrated).

It is possible also for the top (exit) surface to be curved or sloping rather than the bottom surface as this would have the same effect on the collimation of the reflected light. For example, the exit surface can be configured to slope toward the base surface and the light receiving surface.

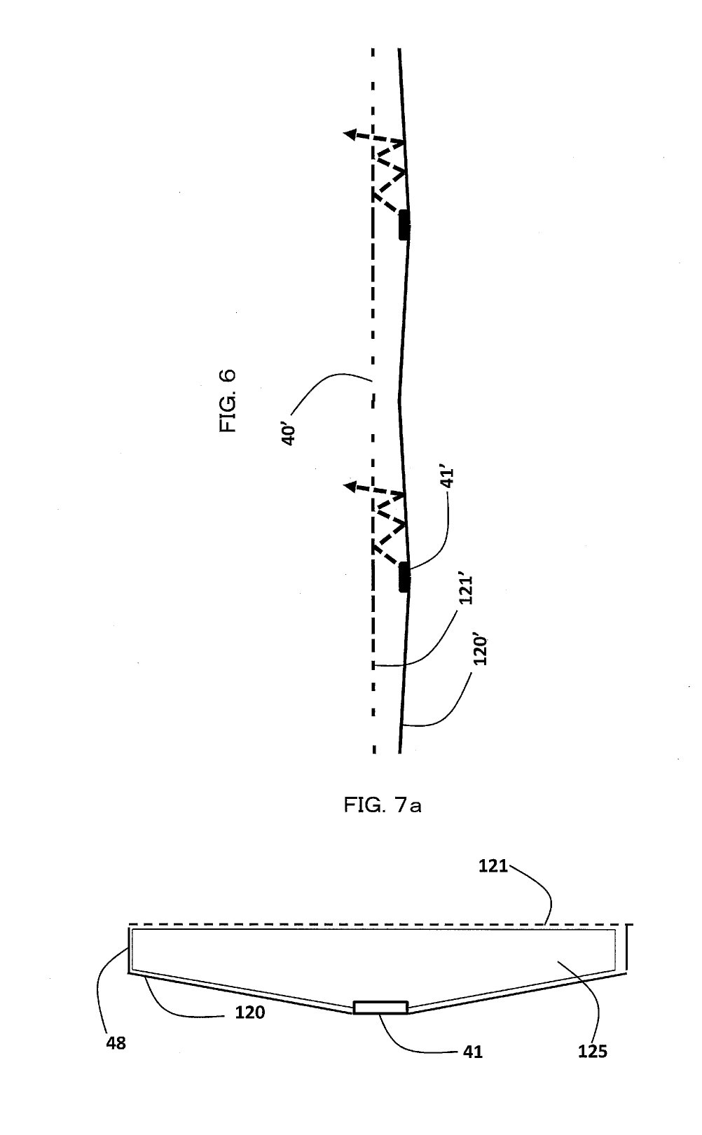

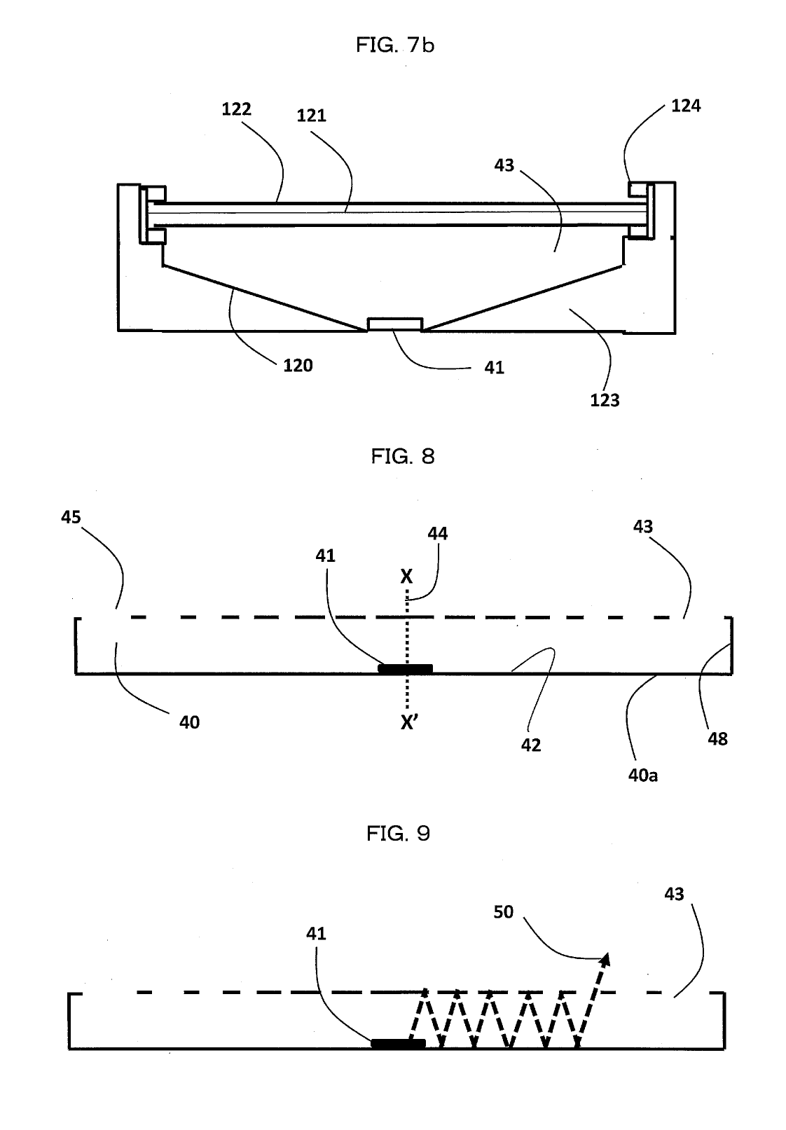

Two methods for the construction of the luminaire are shown in FIG. 7a and 7b. FIG. 7a shows one possible arrangement where the cavity includes a moulded transparent glass or plastic optic 125 of the correct shape. Surrounding this (or on the surface of this) is the specular reflector on the slope 120, side 48 and top surface 121. The reflectors can be deposited onto the surface or glued or otherwise attached. It is important to maintain the surface flatness of these reflectors to preserve performance.

Another method of construction is shown in FIG. 7b. In this case the cavity 43 is air. The slope 120 and side 48 reflectors are deposited on or fixed to plastic or metal supports 123. The top reflector 121 is supported by one or two glass or plastic transparent sheets 122 that can be screwed into the support 123 using a ring or other screw structure 124. This structure can be similar to lens rings.

The screw mounting 124 can also be used to “tune” the angular distribution to a desired level by allowing the user to move the top reflector closer to or further from the light source.

The LED may be glued onto the cavity material so as to form a continuous optical medium or there can be an air gap between the LED and cavity material.

Heatsinking for this luminaire can be done by known methods and can be integrated with the supporting structure of the luminaire.

Subsequent embodiments will be described relative to the preferred embodiment and will be described in reference to this embodiment.

FIG. 6 shows a further extension of this optic whereby multiple LEDs 41′ are arrayed with optic linked to an adjacent optic. The side reflector 48 is then not necessary. The linked optics can be in a square or linear array or a triangle or other arrangement that can but does not need to tessellate.

FIG. 8 shows a cross-section of a reflecting cavity, 40, of a further embodiment with a central light source, 41, arranged in a light receiving surface of a base surface, and holes for light extraction, 43 arranged on an exit surface of the cavity. The reflecting cavity is made from a specularly reflective material, 42, as described above. Opposing walls of the cavity (the exit and base surfaces in the present example) are substantially parallel in this embodiment. A light source is arranged to emit into the cavity, either in the centre, or elsewhere in the cavity. Light emitted from the light source has a well-defined angular extent, for example, emitted into a cone of half-angle 6, 10 or 15 degrees (but could be other, even non-symmetric angular ranges). The light source may be a solid state lighting device—for example one or more light emitting diodes (LED) or laser diodes (LD)—or another source such as, but not limited to, a tungsten filament, metal halide or halogen bulb. This light source would have a collimating optic such as a small reflector on the source in order to collimate the light emission. As the light propagates away from the source, it travels in straight-line paths unless reflected from the cavity walls. This means that, in the plane perpendicular to the luminaire normal axis (the luminaire normal axis is indicated by the line x-x′, 44, which is normal to the exit surface), the light travels in straight radial paths away from the source. As with the first embodiment, light escapes from the cavity when it encounters the holes in the reflective surface, as illustrated in FIG. 9. If the light source has a uniform distribution with respect to the luminaire normal axis and is located in the centre of the cavity, the optimum hole pattern to maximize apparent or actual uniformity of emission over the luminaire surface will have rotational symmetry about the centre of the luminaire. As already stated, because the cavity is made from a specular, rather than diffuse reflector, light rays, 50, travel in straight line paths and are not scattered into new directions. This creates a potential problem—hole shadowing—that requires careful design of hole position as a function of both radius and angle.

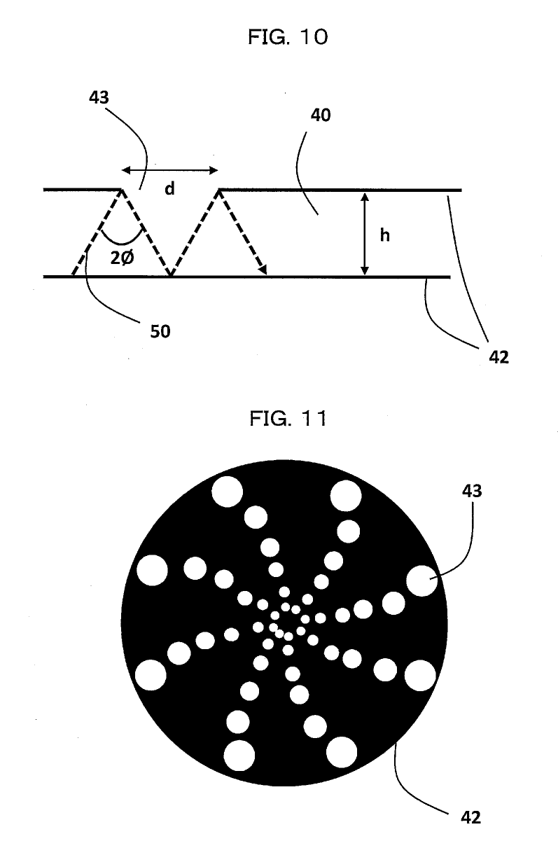

An illustration of the problem of hole shadowing is shown in FIG. 10. Assuming the source has a half angle of emission, Ø, then according to the figure the distance between bounces on one face, d, is given by

d=2*h*tan(Ø) [Math.1]

where h is the height (vertical spacing) of the cavity. If the hole diameter is greater than d, all rays along the radial path through the centre of the hole will be out-coupled, and because reflections are specular that path will not be replenished; any further holes along the same path will not produce any rays. One way to prevent hole shadowing is illustrated in FIG. 11; in this example, the holes are arranged so that they do not lie on constant radii, but are offset in angle as radius increases (the exact design is not necessarily the preferred embodiment because the optimum number and positions of holes may vary according to luminaire size, source, and other constraints. In other words, adjacent holes are angularly offset from one another. The design given is simply to illustrate the need to offset holes relative to those at smaller radii).

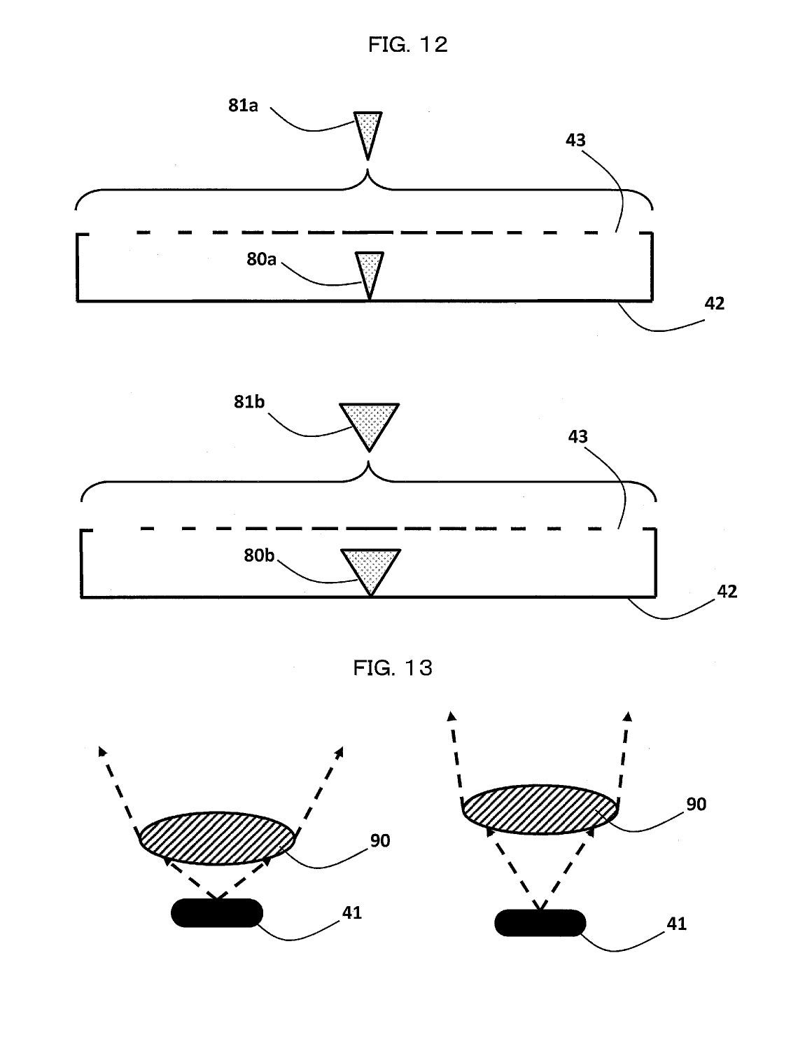

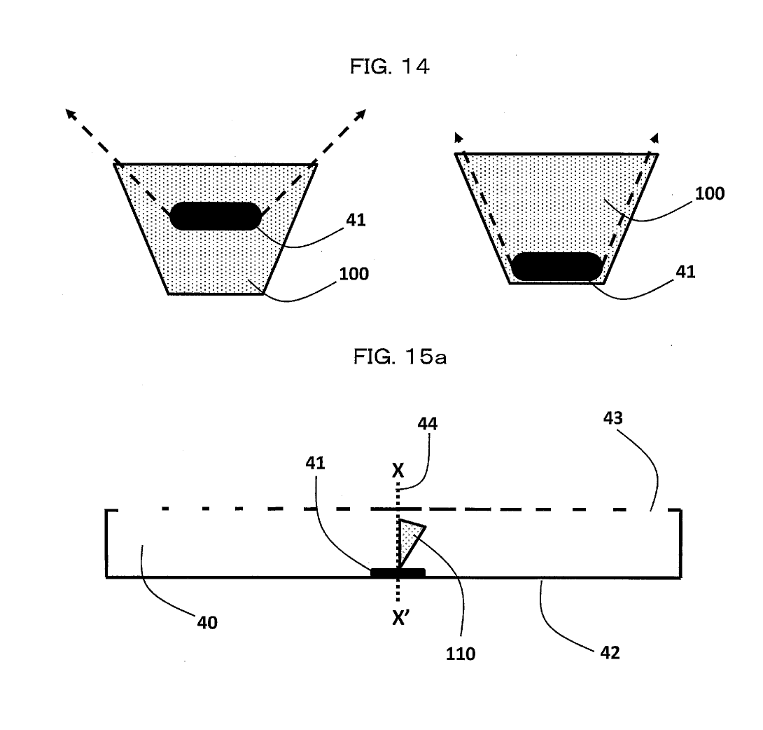

A further embodiment is illustrated in FIG. 12, and refers to the previous embodiments, particularly referring to the embodiment of FIG. 8. This is because the parallel top and bottom surfaces would reproduce the angular profile of the source emitting into it. This embodiment uses a variable emission angle source, 80a,b, in order to create a variable angle luminaire. By varying the angular properties of the light source, the angular properties of the light emitted from the cavity of the luminaire 81a,b is also changed. The variation in angular properties of the light source may be achieved by a number of means; for example, as illustrated in FIG. 13, one or more lenses, 90, may be provided over the light source, with the position of the light source relative to the lens being controllable in order to adjust the angle of emission. Alternatively, the light source may be adjustable within a semi-collimating reflector, 100, as illustrated in FIG. 14. In the case of a single but variable angle light source, the optimum pattern of holes in the reflector could be determined for an average case (for example the mid-point of the range of possible angular emission), or for the angular profile that is expected to be most commonly used. A group of LEDs each with a different optic to change the angular profile can also be used, one or more of them together can be used to create the different distributions. Other methods for variable angle light can also be applied with this optic.

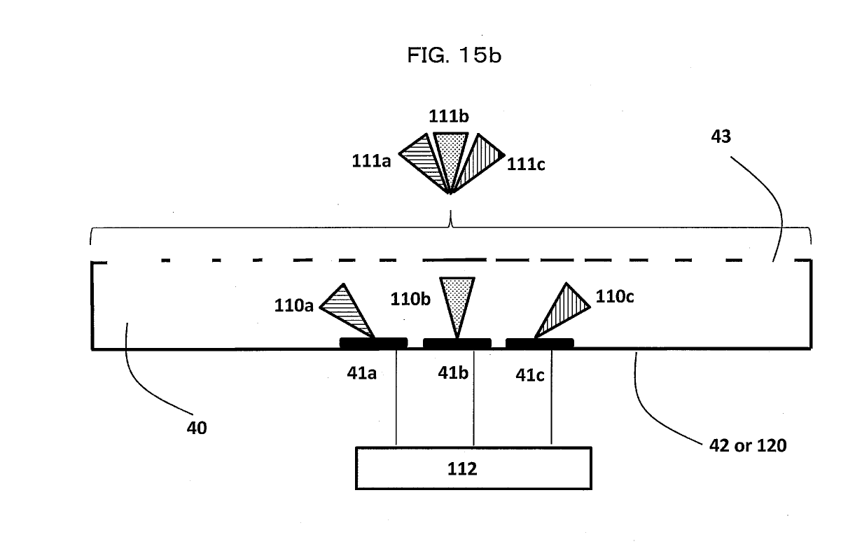

A further embodiment is illustrated in FIG. 15a. This can be applied to any of the embodiments described above, but utilizes a light source with an emission distribution, 110, which is not symmetric about the luminaire axis, 44. In this case, the light source may be placed centrally in the luminaire, or off-centre, but in either case, to maximise uniform emission over the surface of the luminaire the asymmetry in the emission from the source means that the optimum size and distributions of holes will not have rotational symmetry about the position of the light source. There may be multiple LEDs with differing angular distributions. The luminaire will reproduce the angular distribution of the light emitted into it. An illustration of this is shown in FIG. 15b. In this diagram, different sources 41a, b, c (three are illustrated but the number is not limited to three) emit in different directions within the cavity 40. Each will produce a different angular distribution 111a, b, c dependent on the slope of the bottom reflector. If the bottom reflector is parallel 42, then the angular distributions 111a,b,c will be the same as the LED distributions 110a,b,c. If the bottom reflector is sloping, 120 (or negative slope 172) then a different distribution is obtained.

Control of the LEDs 41a,b,c is done with a control unit 112 that can be manually controlled or automatic, for example as a tracking mechanism with a separate camera. Activation of the independent LEDs would create a directional control to the luminaire as a whole.

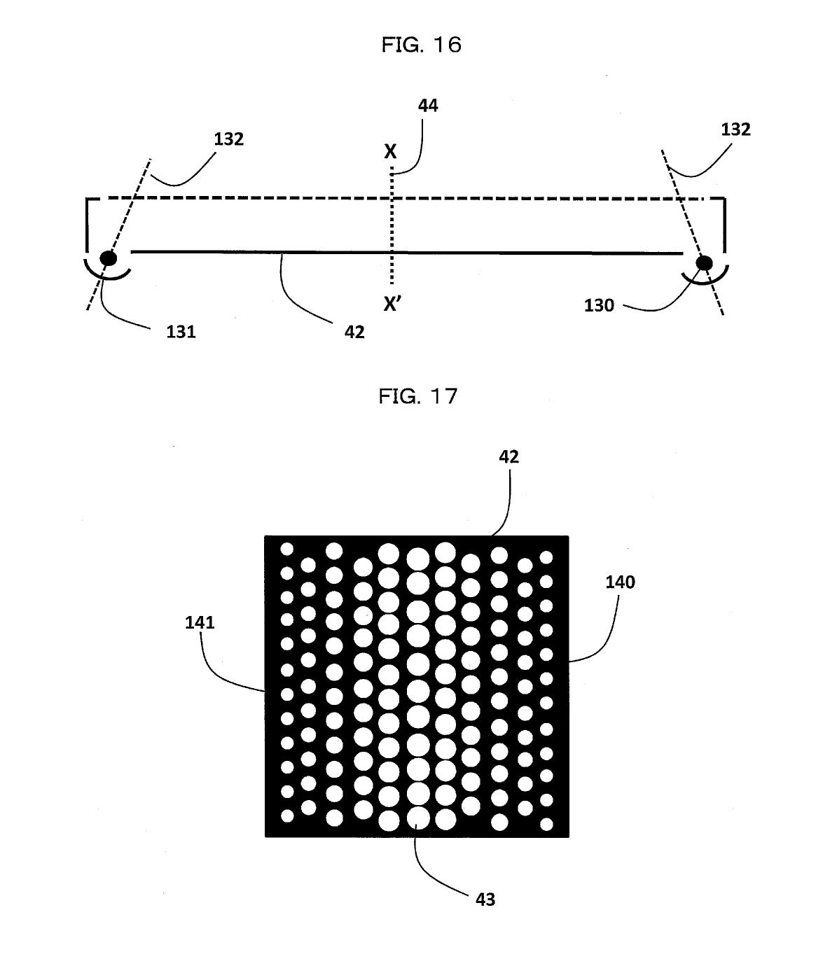

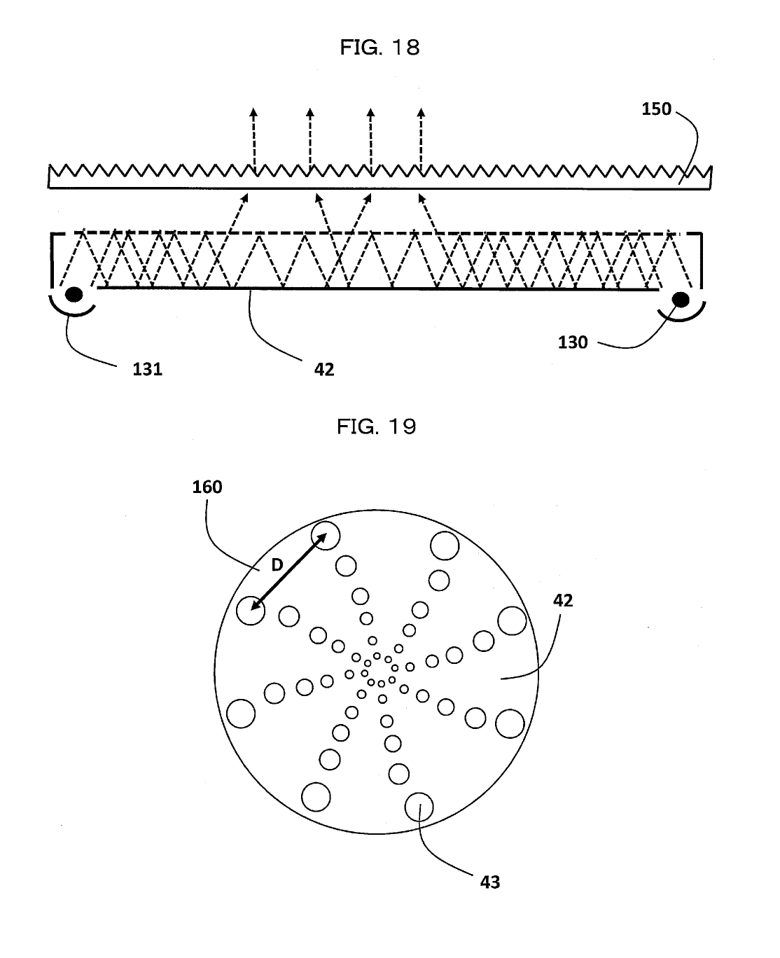

A further embodiment uses the principle of a specularly reflecting cavity outlined in the embodiments above to create a collimated backlight for display devices. To achieve this, collimated light sources are used to provide the light emitted into the cavity. These light sources could be single reflection LEDs (SRLEDs), 130, with reflectors, 131, to provide the desired angular properties, as illustrated in FIG. 16, but the light sources could be provided by other means with the required angular properties. The light sources are located along one or more edges of the cavity, and emit with an optic axis, 132, non-parallel to the luminaire normal axis, and preferentially angled away from the edge on which the light source is located such that light propagates across the cavity via reflections on the bottom and exit surface reflective surfaces. Emission with an axis direction 132 parallel to the top and bottom faces 42 is also possible. The minimum number of light sources needed per side to ensure that light propagates to all parts of the cavity will be determined by the required brightness, size and type of light source, collimation of the emitted light, and the cavity dimensions. Similarly, the positions of holes in the exit surface of the cavity will need to be determined for the required number of sources and geometry; an example, assuming two sets of sources are located down opposite sides, 140 and 141, of the reflective cavity is shown as a top down view in FIG. 17. Multiple LEDs 130, 131 etc. may not have the same collimation or the same direction of emission and can be arrayed in order to maximize uniformity and also to create a controllable collimation and/or direction to the backlight. Depending on the required characteristics of the emitted light, additional optical films, 150, may be used in addition to the backlight, as illustrated in FIG. 18. These optical films may be used to further steer the light after emission from the backlight, for example to increase collimation or change the angle of emission to be closer to the luminaire normal axis. As illustrated the emission direction of the LEDs can be chosen to fit the prism structure of the films in order that a collimated beam of the desired distribution is obtained. Diffusers can also be used to alter angular distribution, smooth out ripples in the distribution and improve uniformity.

A further embodiment concerns the determination of hole size and spacing in the previous embodiments, to further ensure visual comfort. Optionally, hole size and spacing may be designed with an additional constraint specifically to prevent the holes being individually resolvable at a given distance. FIG. 19 illustrates an example of holes to extract light from the reflective cavity; in this case, the maximum distance between holes is shown by D, 160. The typical human eye has an angular resolution of ˜1.7 milliradians, so for a given viewing distance V (the viewing distance V being the distance from the viewer to a surface of the backlight in meters) an acceptable hole spacing may be calculated to ensure that the holes are not individually resolved. This maximum spacing, D, may be calculated approximately by the following formula:

D=tan(1.7×10⁻³)×V

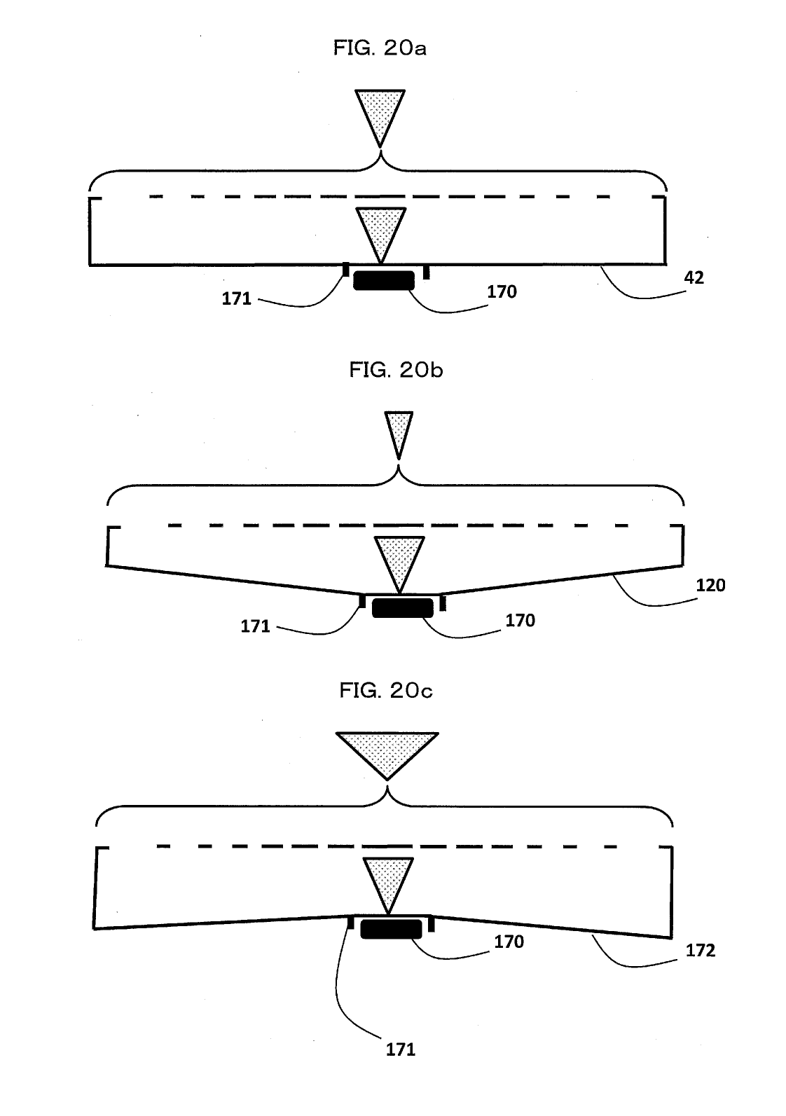

For example, at 1 meter viewing distance a spatial resolution of D=1.7 mm between holes would correspond to an angular separation of 1.7 milliradians. Accordingly, the spacing D between holes is preferably selected such that D<tan(1.7×10⁻³)×V. A further embodiment uses the concept of a reflective cavity with holes for out-coupling light, as described in earlier embodiments, but retrofits this over an existing light, 170. In this regard, greater uniformity and hence reduced glare lighting may be provided in a predefined area that has one or more pre-existing light sources. For example, a reflective cavity can be formed as described herein, and the cavity can be placed in optical communication with the at least one pre-existing light source. The result is a larger area luminaire, but with the same angular emission properties as the original light source. This is illustrated in FIG. 20a. Use of a sloped bottom reflector 120 is shown in FIG. 20b. In this case the adapter unit will collimate the light further from the existing luminaire. Use of the opposite slope, 172 i.e., sloping such that the thickness increases with distance from the source, can be used to increase the angular distribution. All of the aspects of the embodiment of FIG. 20 can be commercially sold separate from a light source and can be attached to an existing luminaire.

This would be useful to reduce harsh glare from downlights and to soften lighting within a room. This can be especially useful for elderly people whose glare response is reduced even though they need high brightnesses of light to maintain visual acuity. This is especially true of some visual disorders such as glaucoma or AMD.

Attachment methods of these optics, 171, can be by screw ring, clamp or other attachment method and can be designed to attach to MR16, PAR or other spotlight or downlight structures.

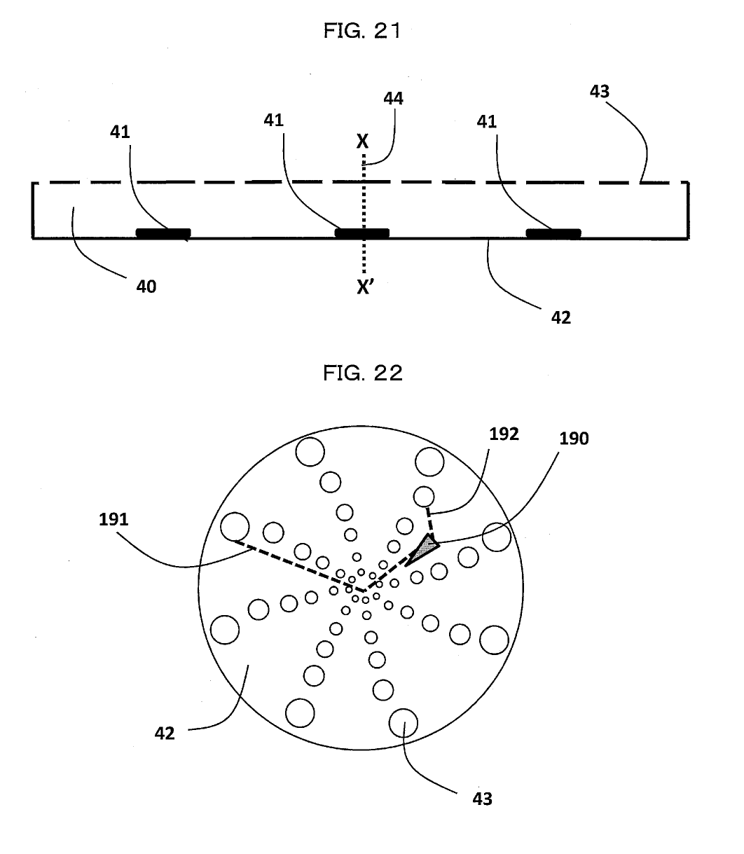

A further embodiment, shown in FIG. 21, places multiple sources, 41, in the cavity in order to create a luminaire. In this case, the increased number of light sources allows for greater flexibility in hole position in the front reflector, as light from more than one light source may contribute to the extracted light at each hole. A second advantage in this arrangement is that the angular properties of the light sources are more advantageously mixed; as described in earlier embodiments, light rays propagate radially from the source, thus light emitted by one source along a radial direction has a narrow angular distribution. By placing multiple sources in the luminaire the angular distribution of light emitted from each hole may be widened, whilst retaining the same overall angular emission from the luminaire.

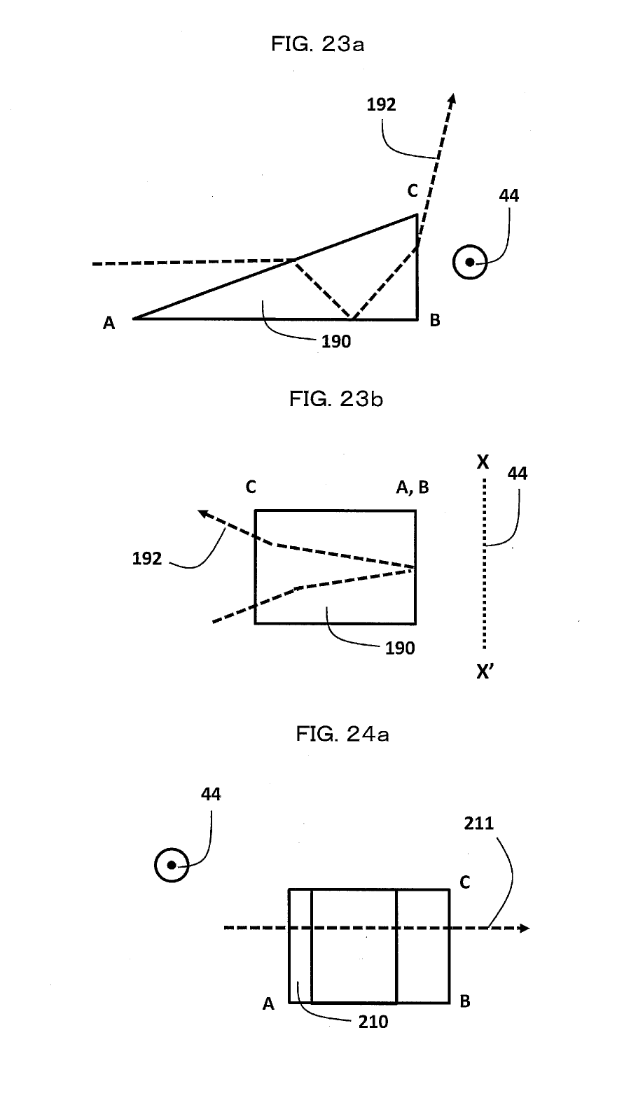

A further embodiment concerns additional deflecting optical features, 190, that may be located between the top and bottom reflective planes within the reflective cavity described in the previous embodiments. This is especially applicable to the embodiment with parallel top and bottom surfaces. The purpose of these features is to interrupt the straight line paths taken by rays in the plane of the luminaire (the plane perpendicular to the luminaire normal axis x-x′). The principle is illustrated in FIG. 22; rays normally travel in straight line paths in the plane illustrated (an example path is shown by 191) instead, the additional deflecting optical feature can alter the path of a ray, 192, out of the otherwise straight line. Deflecting optical features that can alter the paths of rays in the plane of the luminaire but maintain a constant angle in the perpendicular direction could be, for example, prism features. An example is illustrated in FIG. 23; to maintain the same component of direction relative to the luminaire normal axis x-x′, 44, requires that the optical surfaces (those faces that rays may interact with) of the deflecting optical feature, 190, have surface normals perpendicular to the luminaire normal axis. The example deflecting optical feature is shown both viewed from a direction perpendicular to the plane of the luminaire (FIG. 23a) and in the plane of the luminaire (FIG. 23b). If these deflecting optical features are used to spread light rays through the optical cavity it is possible to relax the precision needed in defining the hole positions in the reflective cavity. In addition, the deflecting optical features may be used to provide structural support for the cavity.

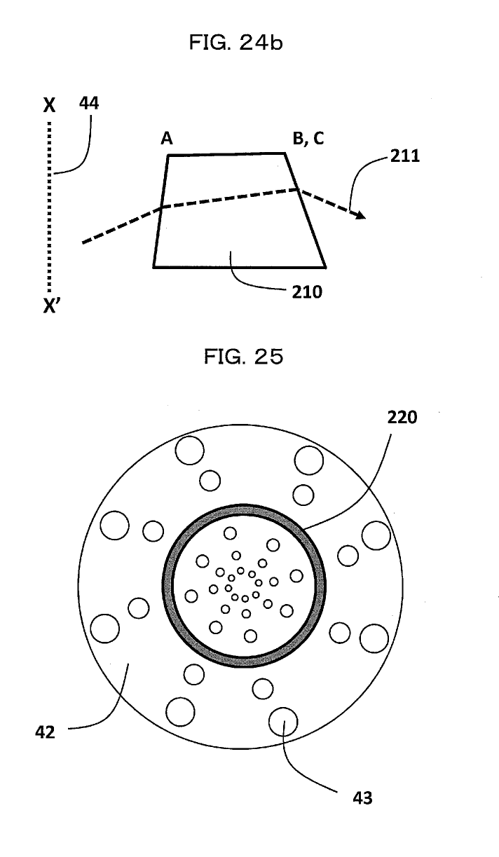

A further embodiment relates to deflecting optical features, 210, within the reflecting cavity described in previous embodiments. In this embodiment, the surface normals of the optical faces of the deflecting optical features are not necessarily perpendicular to the luminaire normal axis. If this is the case, the angle of the light rays, 211, relative to the luminaire normal axis will be altered after passing through a deflecting optical feature. This is illustrated in FIGS. 24a and b. By choosing the refractive index of the optical feature and the angles of the optical faces of the deflecting optical feature, it is possible to determine the range of output angles for a given input angle. This would allow, for example, the angle of light emitted from the luminaire to be controlled further as a function of radius; a factor that could be particularly advantageous because the angle of emitted rays will change as a function of radius, as described in earlier embodiments.

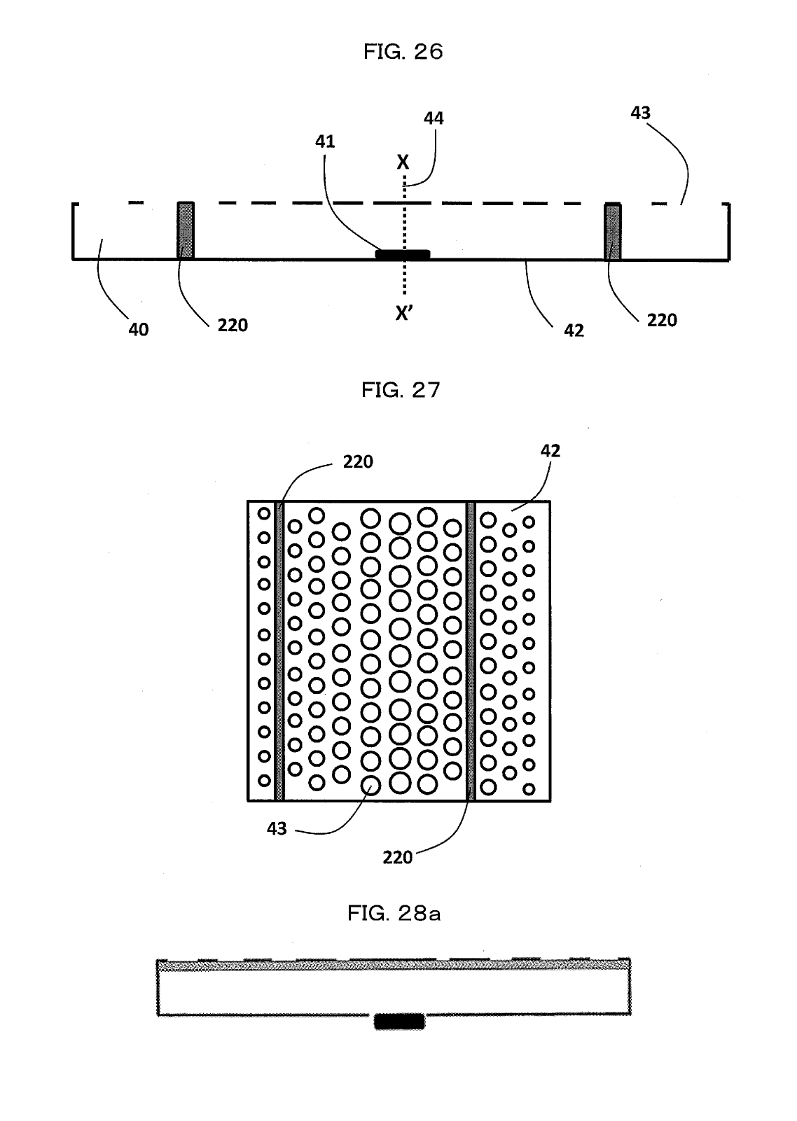

A further embodiment is illustrated in FIG. 25. In this case, instead of one or more single disconnected deflecting optical features, 190, to provide light ray steering as described in embodiments nine and ten, the deflecting optical features could be formed in one or more rings or other continuous geometries, 220, at different distances from the light source or different positions relative to the light source A continuous geometry could be features which form an unbroken ring around and axis that is normal to the exit surface, the ring being circular, rectangular, or another regular or irregular geometry. Alternatively the continuous features may form part of arcs of a circle without necessarily forming an unbroken ring. In the case of all geometries, the deflecting surfaces may be prisms, or any surface features—regular or irregular—that maintain the necessary conditions for the desired ray steering. FIG. 25 illustrates a case where one or more ring geometries might be suitable geometries for the deflecting optical features, 220, and the same system is shown in profile in FIG. 26. Similarly, FIG. 27 illustrates a case where elongated rows of deflecting optical features could be used. The deflecting optical features may be designed to re-direct rays both within the plane of the luminaire, and relative to the luminaire normal, or to combine the two.

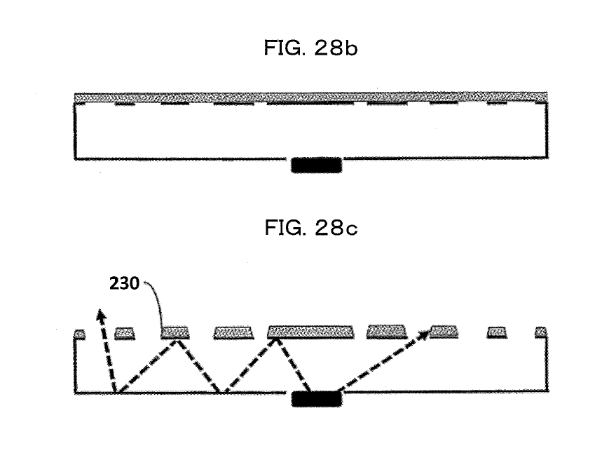

In a further embodiment, additional optical elements can be attached to the bottom or top of the exist surface. FIGS. 28a and 28b show examples of such additional optical elements in the form of diffuser or scattering medium. These optical elements can be placed very close to the exit surface (either at the top or bottom) and can be used to improve color and/or brightness uniformity of the spotlight. For example, the scattering or diffuser medium may be arranged between the exit surface and the base surface, or the exit surface may be arranged between the base surface and the scattering or diffuser medium.

Due to the presence of holes at the exit surface some light rays from the LED can travel through the holes at high angles without interacting with the reflector surfaces in the cavity. Such light rays do not contribute to the brightness of the central light spot and my cause extra glare for the viewer. FIG. 28 (c) shows an optical element 230 which can be scattering, or reflecting, or diffusing, or absorbing, or any combination of such properties. Element 230 is characterized with the presence of similar holes as the exit surface but interacts with high angle light in order to absorb it or change its direction (for example towards the central beam spot). The holes in element 230 can have sloped side walls to minimize interaction with parallel light rays existing the cavity. Such sloped side walls can be achieved by laser cutting for example.

According to one aspect of the invention, the base surface slopes away from the light source or the exit surface slopes toward the base surface.

According to one aspect of the invention, the base surface is parallel to the exit surface.

According to one aspect of the invention, the light receiving surface comprises at least one of a lens or a curved reflector.

According to one aspect of the invention, a size and distribution of the apertures vary with distance and angle away from the light receiving surface.

According to one aspect of the invention, adjacent apertures are angularly offset from one another.

According to one aspect of the invention, the plurality of apertures are arranged on the exit surface such that at least part of each aperture lies on a radial path from the light receiving surface with no apertures present at smaller radii on the path.

According to one aspect of the invention, the device includes the light source arranged relative to the light receiving surface.

According to one aspect of the invention, light emitted by the light source travels in straight radial paths away from the light source in a plane perpendicular to an axis normal to the exit surface.

According to one aspect of the invention, the device includes a variable emission angle source configured to vary an angle of light emitted from the lighting device.

According to one aspect of the invention, the light source is configured to have an emission distribution that is non-symmetric about an axis that is normal to the exit surface.

According to one aspect of the invention, the device includes a plurality of light sources each having differing angular distributions of light, each of the plurality of light sources being individually controllable.

According to one aspect of the invention, the light source comprises a collimated light source.

According to one aspect of the invention, the light source comprises a plurality of light sources each arranged along an edge of the cavity, each of the light sources configured to emit light along an optical axis that is non-parallel to an axis normal to the exit surface.

According to one aspect of the invention, at least some of the light sources are configured to emit light along an axis parallel to the exit surface.

According to one aspect of the invention, the device includes an optical film arranged over the cavity and configured to alter a direction of light emitted from the cavity.

According to one aspect of the invention, for a predetermined viewing distance V a spacing D between adjacent holes is defined by D<tan(1.7×10⁻³)×V.

According to one aspect of the invention, the device includes a plurality of light sources.

According to one aspect of the invention, the device includes a plurality of deflecting optical features arranged within the reflective cavity, the deflecting optical features configured to interrupt a path of light rays that are in a plane perpendicular to a plane normal to the exit surface.

According to one aspect of the invention, a surface normal of optical faces of the deflecting features is non-perpendicular to an axis that is normal to the exit surface.

According to one aspect of the invention, the deflecting optical features comprise a continuous geometry.

According to one aspect of the invention, the light source comprises a light emitting diode (LED).

According to one aspect of the invention, the lighting device includes a scattering or diffuser medium, wherein the scattering or diffuser medium is between the base surface and the exit surface, or the exit surface is between the base surface and the scattering or diffuser medium.

According to one aspect of the invention, the scattering or diffuser medium comprises apertures corresponding to apertures in the exit surface, the apertures including sloped sidewalls to minimize light interaction at the exiting the optical cavity.

According to one aspect of the invention, a backlight comprises the lighting device described herein.

According to one aspect of the invention, a spotlight comprises the lighting device described herein.

Although the invention has been shown and described with respect to a certain embodiment or embodiments, equivalent alterations and modifications may occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein exemplary embodiment or embodiments of the invention. In addition, while a particular feature of the invention may have been described above with respect to only one or more of several embodiments, such feature may be combined with one or more other features of the other embodiments, as may be desired and advantageous for any given or particular application.

### INDUSTRIAL APPLICABILITY

This invention could be utilized in both residential and commercial environments. Spotlights are an increasing use in retail in particular and this invention could allow increased design freedom. Because of the use of the hole pattern, a unique brand image to the luminaire can be created. It is also possible to update existing luminaires with this structure in order to “retrofit” such adaptors onto existing structures. The relative simplicity of the design requires minimal rewiring, and in some cases may be compatible with existing light fixtures. In the case of reduced glare through better uniformity while maintaining brightness when compared to smaller spotlights or downlights this should be particularly suited for lighting for the elderly. Thus, a key market may be lighting located in hospitals, care homes, and similar environments.

The invention can also be used for collimated backlighting for displays encompassing a spatial light modulator, such as a liquid crystal panel. The layer can be used with an array of collimated light sources (that may have the same or different collimation properties and can be individually controllable) in such a manner as to create a uniform plane of collimated light that is closer to the light sources than would otherwise be the case with just air. This would allow a thinner display that can be designed to have electrically switchable angular distribution and/or angular directionality.

The light sources may also be coherent, such as an array of lasers, and the spatial modulator can operate as a controllable holographic image quality of known type. In this case a directed hologram can be created that can be directed according to input data such as the tracking of one or more people viewing the display.

### REFERENCE SIGNS LIST

40. Reflecting cavity
40a. Base surface
41. Light source with well-defined angular extent. (41a,b,c, are different light sources)
42. Specularly reflective material
43. Holes for light extraction
44. Luminaire normal axis
45. Supportive framework for reflective cavity
48. End piece
50. Example light ray path.
80a. Variable emission angle source
80b. Variable emission angle source
81a. Light emitted from luminaire
81b. Light emitted from luminaire
90. Lens used to vary angular emission of light source
100. Reflector used to vary angular emission of light source
110. Light source with an emission distribution which is not symmetric about the luminaire axis (110a,b,c, are different emission distributions)
111a,b,c are different luminaire emission distributions
120. Back face of reflective cavity (120′ an alternate design)
121. Front face of reflective cavity (121′ an alternate design)
123 Plastic or metal mounting
124 Ring or holder mounting
125 Transparent optical substrate
130. SRLED
131. Reflector associated with SRLED
132. Optic axis of SRLED and reflector
140. Side of reflective cavity
141. Side of reflective cavity opposite to side indicated by 140.
150. Additional optical films
160. Maximum distance between holes on front face of reflective cavity.
170. Existing light source which may have reflective cavity retrofit.
171 Attachment structure to existing luminaire
172 negative slope in order to diverge light rather than collimate
190. Additional deflecting optical feature
191. Example ray path
192. Example ray path showing interaction with 190
210. Additional deflecting optical feature to deflect rays relative to the plane of the luminaire
211. Example ray path showing interaction with 210
220. Deflecting optical features in continuous geometries

1. A lighting device, comprising:
a transparent optical cavity including
an exit surface including a specularly reflective material arranged to reflect light into the cavity, the exit surface having a plurality of apertures formed therein,
a base surface including a specularly reflective material arranged to reflect light into the cavity,
at least one light receiving surface arranged relative to the base surface and configured to receive light from a light source,
wherein the plurality of apertures are arranged to maximize at least one of uniformity, angular distribution, efficiency or luminous intensity of light exiting the exit surface,
wherein a distribution of light received at the light receiving surface is altered by at least one of
a combination of the exit surface and the base surface, or
the light receiving surface and
a scattering or diffuser medium, wherein the scattering or diffuser medium is Between the base surface and the exit surface, or the exit surface is between the base Surface and the scattering or diffuser medium,
wherein the scattering or diffuser medium comprises apertures corresponding to Apertures in the exit surface, the apertures including sloped sidewalls to minimize light Interaction at the exiting the optical cavity.

2. The lighting device according to claim 1, wherein the base surface slopes away from the light source or the exit surface slopes toward the base surface.

3. The lighting device according to claim 1, wherein the base surface is parallel to the exit surface.

4. The lighting device according to claim 1, wherein the light receiving surface comprises at least one of a lens shape or a curved reflector.

5. The lighting device according to claim 1, wherein a size and distribution of the apertures vary with distance and angle away from the light receiving surface.

6. The lighting device according to claim 1, wherein adjacent apertures are angularly offset from one another.

7. The lighting device according to claim 1, wherein the plurality of apertures are arranged on the exit surface such that at least part of each aperture lies on a radial path from the light receiving surface with no apertures present at smaller radii on the path.

8. The lighting device according to claim 1, further comprising the light source arranged relative to the light receiving surface.

9. The lighting device according to claim 8, wherein light emitted by the light source travels in straight radial paths away from the light source in a plane perpendicular to an axis normal to the exit surface.

10. The lighting device according to claim 8, further comprising a variable emission angle source configured to vary an angle of light emitted from the lighting device.

11. The lighting device according to claim 8, wherein the light source is configured to have an emission distribution that is non-symmetric about an axis that is normal to the exit surface.

12. The lighting device according to claim 11, further comprising a plurality of light sources each having differing angular distributions of light, each of the plurality of light sources being individually controllable.

13. The lighting device according to claim 8, wherein the light source comprises a collimated light source.

14. The lighting device according to claim 8, wherein the light source comprises a plurality of light sources each arranged along an edge of the cavity, each of the light sources configured to emit light along an optical axis that is non-parallel to an axis normal to the exit surface.

15. The lighting device according to claim 14, wherein at least some of the light sources are configured to emit light along an axis parallel to the exit surface.

16. The lighting device according to claim 1, further comprising an optical film arranged over the cavity and configured to alter a direction of light emitted from the cavity.

17. The lighting device according to claim 1, wherein for a predetermined viewing distance V a spacing D between adjacent holes is defined by D<tan(1.7×10⁻³)×V.

18. (canceled)

19. The lighting device according to claim 1, further comprising a plurality of deflecting optical features arranged within the reflective cavity, the deflecting optical features configured to interrupt a path of light rays that are in a plane perpendicular to a plane normal to the exit surface.

20. The lighting device according to claim 19, wherein a surface normal of optical faces of the deflecting features is non-perpendicular to an axis that is normal to the exit surface.

21. The lighting device according to claim 19, wherein the deflecting optical features comprise a continuous geometry.

22. (canceled)

23. (canceled)

24. (canceled)

25. (canceled)

26. (canceled)
